(19) United States
(12) Patent Application Publication
(10) Pub. No.: US 2018/0176181 A1
(43) Pub. Date: Jun. 21, 2018

(54) ENDPOINT ADMISSION CONTROL

(71) Applicant: CISCO TECHNOLOGY, INC., San Jose, CA (US)

(72) Inventors: Lei Fu, Palo Alto, CA (US); Edward Tung Thanh Pham, San Jose, CA (US); Huilong Huang, Milpitas, CA (US); Srividya S. Vemulakonda, San Jose, CA (US); Mehak Mahajan, San Jose, CA (US); Shyam Kapadia, San Jose, CA (US)

(73) Assignee: CISCO TECHNOLOGY, INC., San Jose, CA (US)

(21) Appl. No.: 15/472,178

(22) Filed: Mar. 28, 2017

Related U.S. Application Data
(60) Provisional application No. 62/435,908, filed on Dec. 19, 2016.

(51) Int. Cl. H04L 29/06; H04L 12/46; H04L 12/801; G06F 17/30; G06F 9/455

(52) U.S. Cl. CPC H04L 63/0236; H04L 12/4641; H04L 47/17; H04L 61/6068; H04L 63/10; G06F 17/30864; G06F 9/45558; H04L 63/1433

(57) ABSTRACT

In an example, there is disclosed a network switch, including: an ingress interface; an egress interface; an endpoint repository network interface; and one or more logic elements including an endpoint admission control engine to: receive a packet on the ingress interface, the packet having an associated source Internet protocol (IP) address and virtual network identifier (VNI); query an endpoint repository via the endpoint repository network interface for the source IP address and VNI; determine that the source IP address and VNI are found in an endpoint repository database of the endpoint repository; and forward the packet to a destination IP address via the egress interface.

### CROSS-REFERENCE TO RELATED APPLICATION

This application claims the benefit of priority under 35 U.S.C. § 119(e) to U.S. Provisional Application Ser. No. 62/435,908 entitled “ENDPOINT ADMISSION CONTROL,” filed Dec. 19, 2016, which is hereby incorporated by reference in its entirety.

### FIELD OF THE SPECIFICATION

This disclosure relates in general to the field of network security, and more particularly, though not exclusively, to a system and method for endpoint admission control.

### BACKGROUND

In a classic computing architecture, a large number of individual user-class machines connected to many different dedicated servers and appliances. Upgrading a user class machine meant buying new hardware, and upgrading a server or appliance meant buying and deploying new hardware.

In modern computing practice, data centers have become more important than individual machines. A user's desktop may be hosted on the network and accessed via a minimalized client device. On the server side, individual servers and appliances have been replaced by large racks of identical servers that are provisioned with virtual machines (VMs) providing the individual functions, controlled by a hypervisor.

In some cases, a virtualized network may also include network function virtualization (NFV), which provides certain network functions as virtual appliances. These functions may be referred to as virtual network functions (VNFs). Other data centers may be based on software-defined networking (SDN), or other similar data center technologies.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1a is a block diagram of a network according to one or more examples of the present specification.

FIG. 1b is a block diagram of selected components of a data center in the network according to one or more examples of the present specification.

FIG. 2 is a block diagram of selected components of an end-user computing device according to one or more examples of the present specification.

FIG. 3 is a high-level block diagram of a server according to one or more examples of the present specification.

FIG. 4 is a block diagram of a data center in a leaf spine architecture according to one or more examples of the present specification.

FIG. 5 is a block diagram of the data center according to one or more examples of the present specification.

FIG. 6 is a block diagram of a switch 600 according to one or more examples of the present specification.

FIG. 7 is a flowchart of a method 700 of performing endpoint control according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

In the modern cloud environment, perimeter security (e.g., traditional firewall appliances that inspect and permit or deny traffic at the enterprise boundary) may not be sufficient to protect the data center. Rather, in modern practice, vulnerabilities may exist within the data center itself, either because a machine has been compromised by a malicious actor, or because a machine is misconfigured and may cause inadvertent harm to the network. Indeed, in many modern data centers, the majority of traffic is now “east to west,” meaning that, from a security standpoint, as much attention may need to be paid to what is going on inside the network as to what is coming in from outside the network.

By way of example, Cisco® provides a “Programmable Fabric,” based on a spine leaf “Clos” topology for networks with either static or dynamic workloads. For dynamic provisioning, various end host detection triggers may be employed—for example, vCenter notifications, LLDP/VDP protocol notifications, incoming data packets, or similar. The network is provisioned to distribute the host route (/32 or /128) within the fabric using a border gateway protocol (BGP). Thus, every end host within the fabric has reachability to every other end host, providing true any-to-any connectivity.

Depending on the needs of a particular deployment, the end host may be a “bare metal” (true hardware) host, or a virtual workload. With virtual machines, an orchestrator like OpenStack or a virtual machine manager (VMM) like VMware vCenter may be employed for managing the compute and server resources, SCRI scale, and to manage the orchestration. However, the environment can still be compromised. For example, a VM could be running an application that is infected by a virus, or a VM could be assigned to an incorrect network and/or incorrect IP address, such as by an incorrect manual configuration, or an incorrect script. Such compromises can be usefully referred to as “malicious activity,” though it should be noted that the activity need not be deliberate (as in the case of inadvertent misconfiguration). By the time the malicious activity is detected and remedial action taken (for example, installing appropriate Access Control Lists), there may already be damage to the network, requiring further remediation.

Misbehaving devices become even more challenging in the presence of a distributed IP anycast gateway. This may require a more proactive and preventive approach that is distributed so that misbehaving devices can be detected and appropriate action taken even before they are “admitted” to pass traffic. To this end, the present specification provides host admission control within the data center fabric, without the need for any new additional hardware appliances or sophisticated service nodes.

To achieve this, embodiments of the present system enforce end host admission control as follows:
a. End host identities (including VMs and bare metal machines) are stored in a database (called herein an “endpoint repository”) that is accessible via the management plane.
b. Before passing traffic to an end host, the switch first validates the end host with its identity.
c. Only an end host with a validated identity is admitted into the network and is subsequently allowed to send traffic and receive traffic.

By way of concrete example, in Cisco's® programmable fabric, data center network manager (DCNM) is a central management entity that performs overlay/underlay provisioning as well as managing and monitoring the data center. DCNM may also serve as the SDN controller for the fabric.

An endpoint repository can be maintained within the DCNM. The endpoint repository could also be stored externally, as long as it is accessible to the DCNM or the switch. Embodiments of DCNM include an OpenLDAP server packaged with DCNM that can provide an engine for the endpoint repository. The endpoint repository may include fields such as MAC, IP, layer 2 virtual network identifier (L2VNI), L3VNI, and endpoint name, by way of nonlimiting example. In a virtual extensible LAN (VXLAN) border gateway protocol (BGP) Ethernet virtual private network (EVPN) architecture, the unique combination of L2VNI and IP may serve as the primary key.

In an example workflow, two leafs are interconnected via a single spine. A virtualized compute node is connected to each leaf, on which endpoints are spawned (in this case, virtual machines). The LDAP server hosts the endpoint repository.

Before sending any traffic, the endpoints obtain an IP address via DHCP or static configuration. The endpoint may want to communicate with other endpoints, either in the same subnet or a different subnet. For this purpose, the endpoints send out an ARP request. For same-subnet communication (also known as a bridged scenario), the broadcast ARP request is for the destination endpoint's IP to MAC binding. For across-subnet scenarios, the ARP request is for resolution of the subnet default gateway. In either scenario, with ARP snooping enabled on the leaf, ARP requests are redirected to a verification engine. The verification engine receives the incoming packet and obtains the mapped L2VNI via a query to the VLAN manager component.

At this point, the ARP module queries the endpoint repository hosted on the LDAP server, with, for example, IP and L2VNI as the lookup key.

If the endpoint repository returns a match, then the endpoint is to be admitted. A new ARP entry for the endpoint may then be added to the ARP cache, which in turn will result in an appropriate /32 route being populated by remote leafs, thereby ensuring optimal reachability of information distribution within the fabric.

On the other hand, if the endpoint repository returns no match, then this endpoint may not be valid. The ARP packet is dropped and no entry is added to the ARP cache. Appropriate SYSLOGs and notifications may then be sent from the barred entry into the data center fabric so that the network administrator can take appropriate action. Furthermore, there may be a policy enforced by the network administrator, wherein an appropriate access control list (ACL) or endpoint-based rate limiter (depending on hardware) can drop these invalid hosts without burdening the CPU. To prevent exhaustion of hardware resources in case of a burst of invalid endpoints sending ARPs, some thresholds can be preset. At the extreme, the port on which these bursts are received may be shut and the network administrator informed to take further action.

Thus, endpoint traffic is admitted into the fabric in a controlled manner. Once an endpoint has been validated, subsequent ARP packets from the endpoint are processed normally. For switches configured as a VPC pair, whichever switch receives the ARP request may perform the preceding method. Once a VPC peer validates an endpoint, the information is synced over to its adjacent peer as part of an extension to the existing VPC ARP sync process. Note that the same process may be employed for IPv6 endpoints by special processing of neighbor discovery (ND) messages.

For a matched entry, the endpoint repository entry may be optionally updated to indicate the leaf/ToR under which the endpoint resides. This, in turn, can be used in the future to detect and block endpoints misconfigured with the same IP address.

Also note that this protocol provides a mechanism for admission control from a network point of view. Two VMs on the same server that are part of the same network may still communicate with each other directly via the attached virtual switch since this does not involve the ToR or leaf switch. If admission control is also required, then one option is to disable local switching on the virtual switch and have all traffic be switched via the ToR/leaf switch (similar to the virtual machine fabric extender (VM-FEX)).

A system and method for endpoint admission control will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

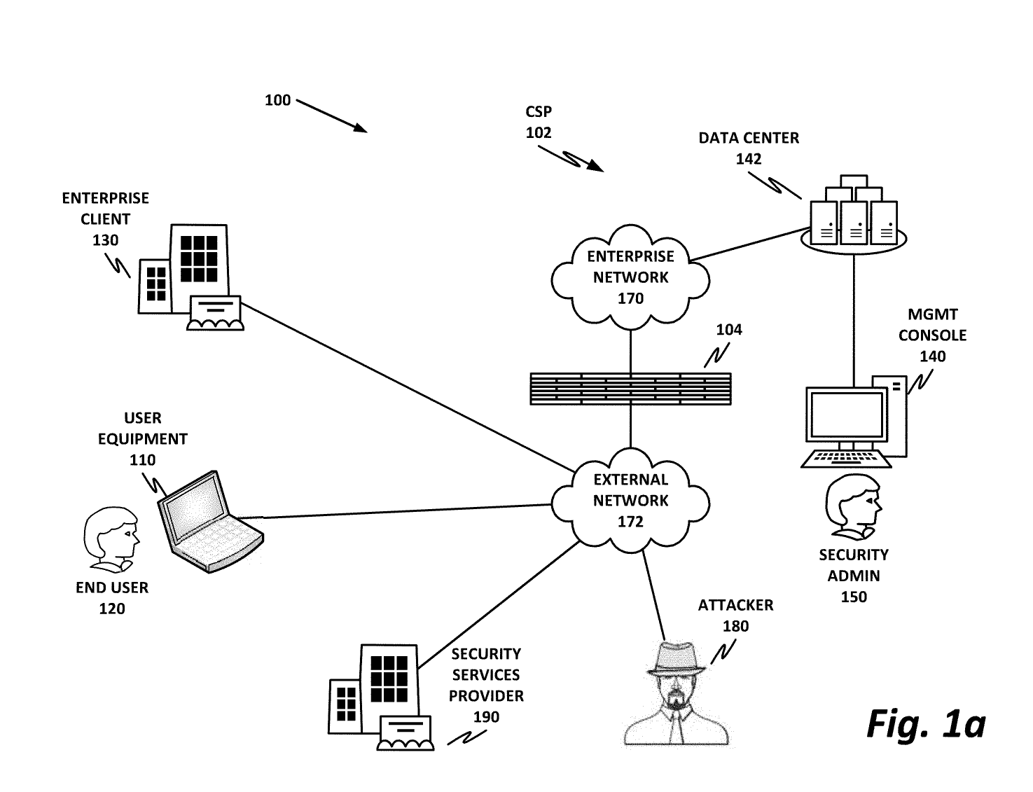

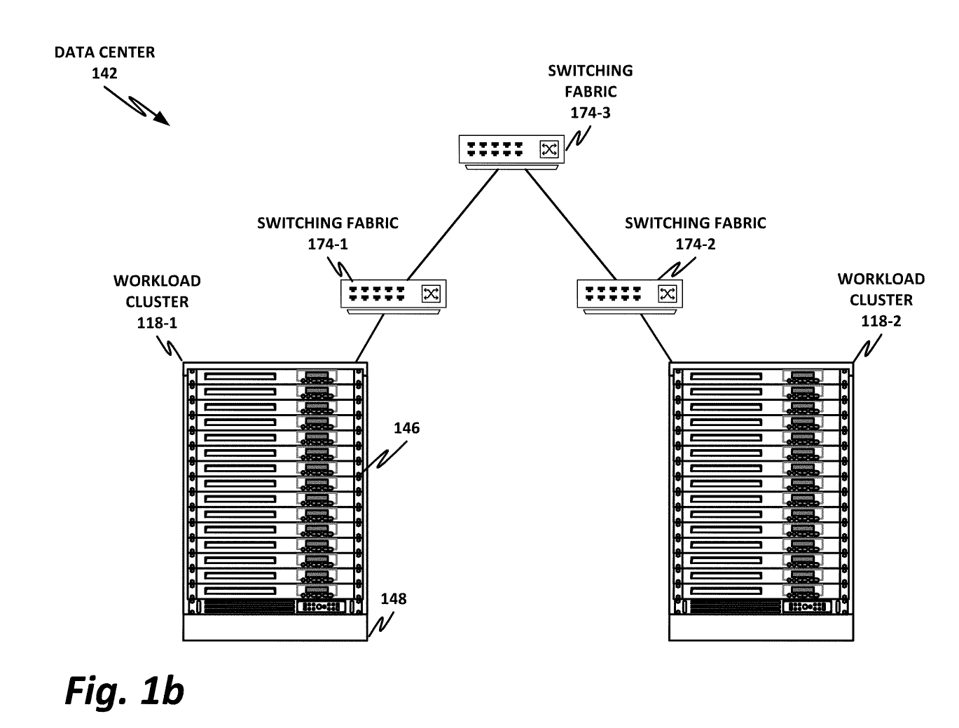

FIG. 1a is a network-level diagram of a network 100 of a cloud service provider (CSP) 102 according to one or more examples of the present specification. In the example of FIG. 1a, network 100 may be configured to enable one or more enterprise clients 130 to provide services or data to one or more end users 120, who may operate user equipment 110 to access information or services via external network 172. This example contemplates an embodiment in which a cloud service provider 102 is itself an enterprise that provides third-party “network as a service” (NaaS) to enterprise client 130. However, this example is nonlimiting. Enterprise client 130 and CSP 102 could also be the same or a related entity in appropriate embodiments.

Enterprise network 170 may be any suitable network or combination of one or more networks operating on one or more suitable networking protocols, including, for example, a fabric, a local area network, an intranet, a virtual network, a wide area network, a wireless network, a cellular network, or the Internet (optionally accessed via a proxy, virtual machine, or other similar security mechanism) by way of nonlimiting example. Enterprise network 170 may also include one or more servers, firewalls, routers, switches, security appliances, antivirus servers, or other useful network devices, which in an example may be virtualized within data center 142. In this illustration, enterprise network 170 is shown as a single network for simplicity, but in some embodiments, enterprise network 170 may include a large number of networks, such as one or more enterprise intranets connected to the Internet, and may include data centers in a plurality of geographic locations. Enterprise network 170 may also provide access to an external network, such as the Internet, via external network 172. External network 172 may similarly be any suitable type of network.

A data center 142 may be provided, for example, as a virtual cluster running in a hypervisor on a plurality of rackmounted blade servers, or as a cluster of physical servers. Data center 142 may provide one or more server functions, one or more VNFs, or one or more “microclouds” to one or more tenants in one or more hypervisors. For example, a virtualization environment such as vCenter may provide the ability to define a plurality of “tenants,” with each tenant being functionally separate from each other tenant, and each tenant operating as a single-purpose microcloud. Each microcloud may serve a distinctive function, and may include a plurality of virtual machines (VMs) of many different flavors. In some embodiments, data center 142 may also provide multitenancy, in which a single instance of a function may be provided to a plurality of tenants, with data for each tenant being insulated from data for each other tenant.

It should also be noted that some functionality of user equipment 110 may also be provided via data center 142. For example, one microcloud may provide a remote desktop hypervisor such as a Citrix workspace, which allows end users 120 to log in to a remote enterprise desktop and access enterprise applications, workspaces, and data. In that case, UE 110 could be a “thin client” such as a Google Chromebook, running only a stripped-down operating system, and still provide user 120 useful access to enterprise resources.

One or more computing devices configured as a management console 140 may also operate on enterprise network 170. Management console 140 may be a special case of user equipment, and may provide a user interface for a security administrator 150 to define enterprise security and network policies, which management console 140 may enforce on enterprise network 170 and across client devices 110 and data center 142. In an example, management console 140 may run a server-class operating system, such as Linux, Unix, or Windows Server. In another case, management console 140 may be provided as a web interface, on a desktop-class machine, or via a VM provisioned within data center 142.

Network 100 may communicate across enterprise boundary 104 with external network 172. Enterprise boundary 104 may represent a physical, logical, or other boundary. External network 172 may include, for example, websites, servers, network protocols, and other network-based services. CSP 102 may also contract with a third-party security services provider 190 to provide security services to network 100.

It may be a goal of enterprise clients to securely provide network services to end users 120 via data center 142, as hosted by CSP 102. To that end, CSP 102 may provide certain contractual quality of service (QoS) guarantees and/or service level agreements (SLAs). QoS may be a measure of resource performance, and may include factors such as availability, jitter, bit rate, throughput, error rates, and latency, to name just a few. An SLA may be a contractual agreement that may include QoS factors, as well as factors such as “mean time to recovery” (MTTR) and mean time between failure (MTBF). In general, an SLA may be a higher-level agreement that is more relevant to an overall experience, whereas QoS may be used to measure the performance of individual components. However, this should not be understood as implying a strict division between QoS metrics and SLA metrics.

Turning to FIG. 1b, to meet contractual QoS and SLA requirements, CSP 102 may provision some number of workload clusters 118. In this example, two workload clusters, 118-1 and 118-2 are shown, each providing up to 16 rackmount servers 146 in a chassis 148. These server racks may be collocated in a single data center, or may be located in different geographic data centers. Depending on the contractual agreements, some servers 146 may be specifically dedicated to certain enterprise clients or tenants, while others may be shared.

Selection of a number of servers to provision in a data center is a nontrivial exercise for CSP 102. CSP 102 may wish to ensure that there are enough servers to handle network capacity, and to provide for anticipated device failures over time. However, provisioning too many servers 146 can be costly both in terms of hardware cost, and in terms of power consumption. Thus, ideally, CSP 102 provisions enough servers 146 to service all its enterprise clients 130 and meet contractual QoS and SLA benchmarks, but not have wasted capacity.

The various devices in data center 142 may be connected to each other via a switching fabric 174, which may include one or more high speed routing and/or switching devices. In some cases, switching fabric 174 may be hierarchical, with, for example, switching fabric 174-1 handling workload cluster 118-1, switching fabric 174-2 handling workload cluster 118-2, and switching fabric 174-3. This simple hierarchy is shown to illustrate the principle of hierarchical switching fabrics, but it should be noted that this may be significantly simplified compared to real-life deployments. In many cases, the hierarchy of switching fabric 174 may be multifaceted and much more involved. Common network architectures include hub-and-spoke architectures and leaf spine architectures.

The fabric itself may be provided by any suitable interconnect, such as those provided by Cisco® MDS fabric switches, Ultra Path Interconnect (UPI) (formerly called QPI or KTI), STL, Ethernet, PCI, or PCIe, to name just a few. Some of these will be more suitable for certain types of deployments than others, and selecting an appropriate fabric for the instant application is an exercise of ordinary skill.

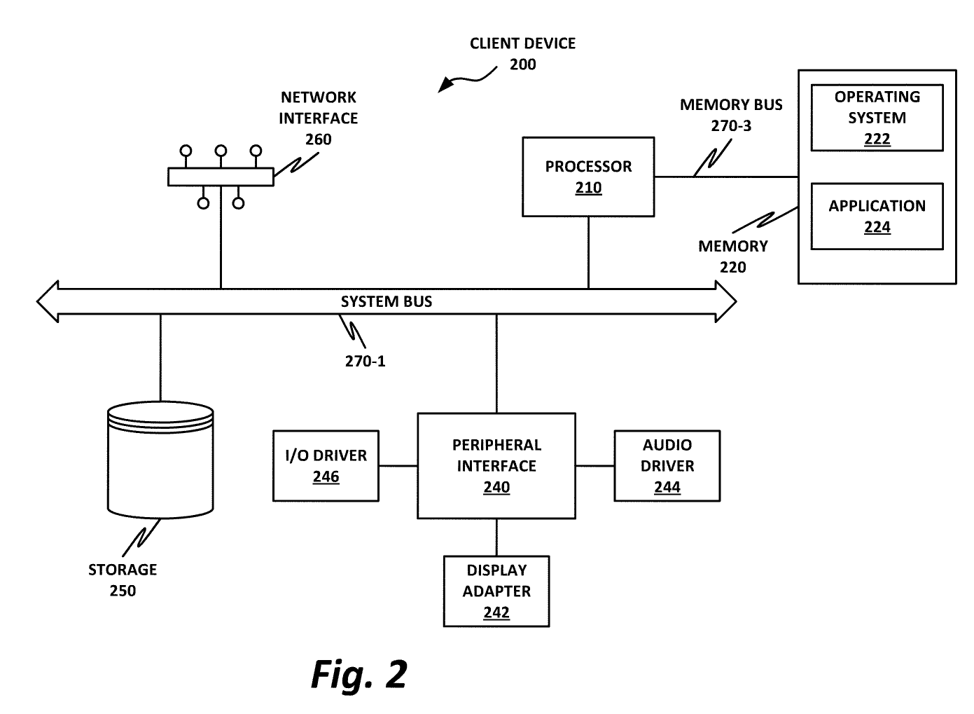

FIG. 2 is a block diagram of client device 200 according to one or more examples of the present specification. Client device 200 may be any suitable computing device. In various embodiments, a “computing device” may be or comprise, by way of nonlimiting example, a computer, workstation, server, mainframe, virtual machine (whether emulated or on a “bare-metal” hypervisor), embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data. Any computing device may be designated as a host on the network. Each computing device may refer to itself as a “local host,” while any computing device external to it may be designated as a “remote host.” In particular, user equipment 110 may be a client device 200, and in one particular example, client device 200 is a virtual machine configured for RDMA as described herein.

Client device 200 includes a processor 210 connected to a memory 220, having stored therein executable instructions for providing an operating system 222 and at least software portions of an application 224. Other components of client device 200 include a storage 250, network interface 260, and peripheral interface 240. This architecture is provided by way of example only, and is intended to be nonexclusive and nonlimiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices, such as in the case of a data center storage pool or memory server. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block.

As used throughout this specification, “logic elements” may include hardware (including, for example, a programmable software, application-specific integrated circuit (ASIC), or field-programmable gate array (FPGA)), external hardware (digital, analog, or mixed-signal), software, reciprocating software, services, drivers, interfaces, components, modules, algorithms, sensors, components, firmware, microcode, programmable logic, or objects that can coordinate to achieve a logical operation. Furthermore, some logic elements are provided by a tangible, nontransitory computer-readable medium having stored thereon executable instructions for instructing a processor to perform a certain task. Such a nontransitory medium could include, for example, a hard disk, solid state memory or disk, read-only memory (ROM), persistent fast memory (PFM) (e.g., Intel® 3D Crosspoint), external storage, redundant array of independent disks (RAID), redundant array of independent nodes (RAIN), network-attached storage (NAS), optical storage, tape drive, backup system, cloud storage, or any combination of the foregoing by way of nonlimiting example. Such a medium could also include instructions programmed into an FPGA, or encoded in hardware on an ASIC or processor.

In an example, processor 210 is communicatively coupled to memory 220 via memory bus 270-3, which may be, for example, a direct memory access (DMA) bus. However, other memory architectures are possible, including ones in which memory 220 communicates with processor 210 via system bus 270-1 or some other bus. In data center environments, memory bus 270-3 may be, or may include, the fabric.

Processor 210 may be communicatively coupled to other devices via a system bus 270-1. As used throughout this specification, a “bus” includes any wired or wireless interconnection line, network, connection, fabric, bundle, single bus, multiple buses, crossbar network, single-stage network, multistage network, or other conduction medium operable to carry data, signals, or power between parts of a computing device, or between computing devices. It should be noted that these uses are disclosed by way of nonlimiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including, by way of nonlimiting example, a microprocessor, digital signal processor (DSP), field-programmable gate array (FPGA), graphics processing unit (GPU), programmable logic array (PLA), application-specific integrated circuit (ASIC), or virtual machine processor. In certain architectures, a multicore processor may be provided, in which case processor 210 may be treated as only one core of a multicore processor, or may be treated as the entire multicore processor, as appropriate. In some embodiments, one or more coprocessors may also be provided for specialized or support functions.

Processor 210 may be connected to memory 220 in a DMA configuration via bus 270-3. To simplify this disclosure, memory 220 is disclosed as a single logical block, but in a physical embodiment may include one or more blocks of any suitable volatile or nonvolatile memory technology or technologies, including, for example, double data rate random access memory (DDR RAM), static random access memory (SRAM), dynamic random access memory (DRAM), persistent memory, cache, L1 or L2 memory, on-chip memory, registers, flash, ROM, optical media, virtual memory regions, magnetic or tape memory, or similar. Memory 220 may be provided locally, or may be provided elsewhere, such as in the case of a data center with a 3DXP memory server. In certain embodiments, memory 220 may comprise a relatively low-latency volatile main memory, while storage 250 may comprise a relatively higher-latency, nonvolatile memory. However, memory 220 and storage 250 need not be physically separate devices, and in some examples may represent simply a logical separation of function. These lines can be particularly blurred in cases where the only long-term memory is a battery-backed RAM, or where the main memory is provided as PFM. It should also be noted that although DMA is disclosed by way of nonlimiting example, DMA is not the only protocol consistent with this specification, and that other memory architectures are available.

Operating system 222 may be provided, though it is not necessary in all embodiments. For example, some embedded systems operate on “bare metal” for purposes of speed, efficiency, and resource preservation. However, in contemporary systems, it is common for even minimalist embedded systems to include some kind of operating system. Where it is provided, operating system 222 may include any appropriate operating system, such as Microsoft Windows, Linux, Android, Mac OSX, Apple iOS, Unix, or similar. Some of the foregoing may be more often used on one type of device than another. For example, desktop computers or engineering workstations may be more likely to use one of Microsoft Windows, Linux, Unix, or Mac OSX. Laptop computers, which are usually a portable off-the-shelf device with fewer customization options, may be more likely to run Microsoft Windows or Mac OSX. Mobile devices may be more likely to run Android or iOS. Embedded devices often use an embedded Linux or a dedicated embedded OS such as VxWorks. However, these examples are not intended to be limiting.

Storage 250 may be any species of memory 220, or may be a separate nonvolatile memory device. Storage 250 may include one or more nontransitory computer-readable mediums, including, by way of nonlimiting example, a hard drive, solid-state drive, external storage, redundant array of independent disks (RAID), redundant array of independent nodes (RAIN), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of application 224. In some examples, storage 250 may be a nontransitory computer-readable storage medium that includes hardware instructions or logic encoded as processor instructions or on an ASIC. Many other configurations are also possible, and are intended to be encompassed within the broad scope of this specification.

Network interface 260 may be provided to communicatively couple client device 200 to a wired or wireless network. A “network,” as used throughout this specification, may include any communicative platform or medium operable to exchange data or information within or between computing devices, including, by way of nonlimiting example, Ethernet, WiFi, a fabric, an ad-hoc local network, an Internet architecture providing computing devices with the ability to electronically interact, a plain old telephone system (POTS, which computing devices could use to perform transactions in which they may be assisted by human operators or in which they may manually key data into a telephone or other suitable electronic equipment), any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment. Note that in certain embodiments, network interface 260 may be, or may include, a host fabric interface (HFI).

Application 224, in one example, is operable to carry out computer-implemented methods as described in this specification. Application 224 may include one or more tangible nontransitory computer-readable mediums having stored thereon executable instructions operable to instruct a processor to provide an application 224. Application 224 may also include a processor, with corresponding memory instructions that instruct the processor to carry out the desired method. As used throughout this specification, an “engine” includes any combination of one or more logic elements, of similar or dissimilar species, operable for and configured to perform one or more methods or functions of the engine. In some cases, application 224 may include a special integrated circuit designed to carry out a method or a part thereof, and may also include software instructions operable to instruct a processor to perform the method. In some cases, application 224 may run as a “daemon” process. A “daemon” may include any program or series of executable instructions, whether implemented in hardware, software, firmware, or any combination thereof that runs as a background process, a terminate-and-stay-resident program, a service, system extension, control panel, bootup procedure, basic input/output system (BIOS) subroutine, or any similar program that operates without direct user interaction. In certain embodiments, daemon processes may run with elevated privileges in a “driver space” associated with ring 0, 1, or 2 in a protection ring architecture. It should also be noted that application 224 may also include other hardware and software, including configuration files, registry entries, and interactive or user-mode software by way of nonlimiting example.

In one example, application 224 includes executable instructions stored on a nontransitory medium operable to perform a method according to this specification. At an appropriate time, such as upon booting client device 200 or upon a command from operating system 222 or a user 120, processor 210 may retrieve a copy of the instructions from storage 250 and load it into memory 220. Processor 210 may then iteratively execute the instructions of application 224 to provide the desired method.

Peripheral interface 240 may be configured to interface with any auxiliary device that connects to client device 200 but that is not necessarily a part of the core architecture of client device 200. A peripheral may be operable to provide extended functionality to client device 200, and may or may not be wholly dependent on client device 200. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage by way of nonlimiting example.

In one example, peripherals include display adapter 242, audio driver 244, and input/output (IO) driver 246. Display adapter 242 may be configured to provide a human-readable visual output, such as a command-line interface (CLI) or graphical desktop such as Microsoft Windows, Apple OSX desktop, or a Unix/Linux X Window System-based desktop. Display adapter 242 may provide output in any suitable format, such as a coaxial output, composite video, component video, VGA, or digital outputs such as DVI or HDMI, by way of nonlimiting example. In some examples, display adapter 242 may include a hardware graphics card, which may have its own memory and its own graphics processing unit (GPU). Audio driver 244 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of nonlimiting example. Note that in embodiments where client device 200 is a virtual machine, peripherals may be provided remotely by a device used to access the virtual machine.

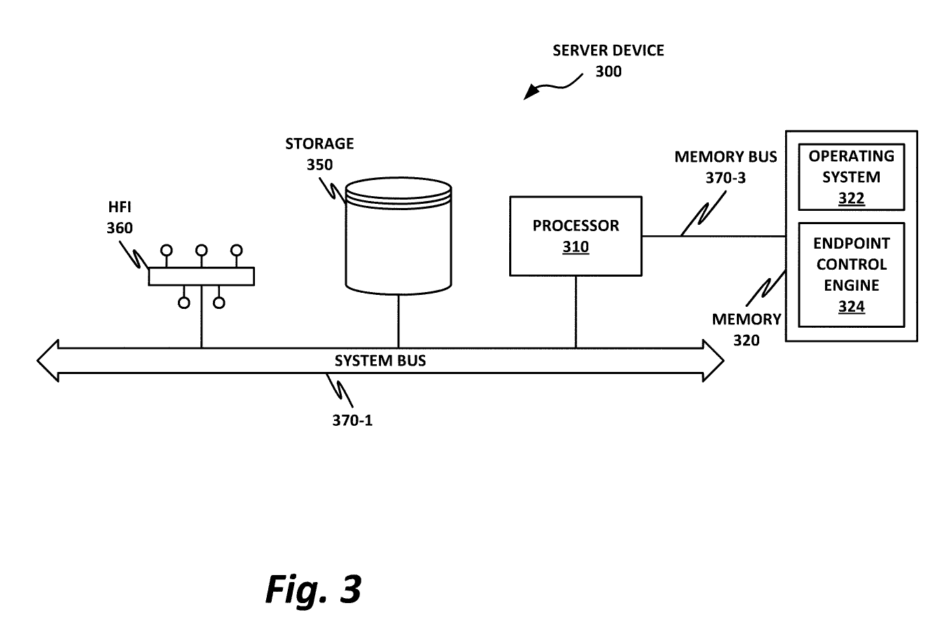

FIG. 3 is a block diagram of a server-class device 300 according to one or more examples of the present specification. Server 300 may be any suitable computing device, as described in connection with FIG. 2. In general, the definitions and examples of FIG. 2 may be considered as equally applicable to FIG. 3, unless specifically stated otherwise. Server 300 is described herein separately to illustrate that in certain embodiments, logical operations may be divided along a client-server model, wherein client device 200 provides certain localized tasks, while server 300 provides certain other centralized tasks.

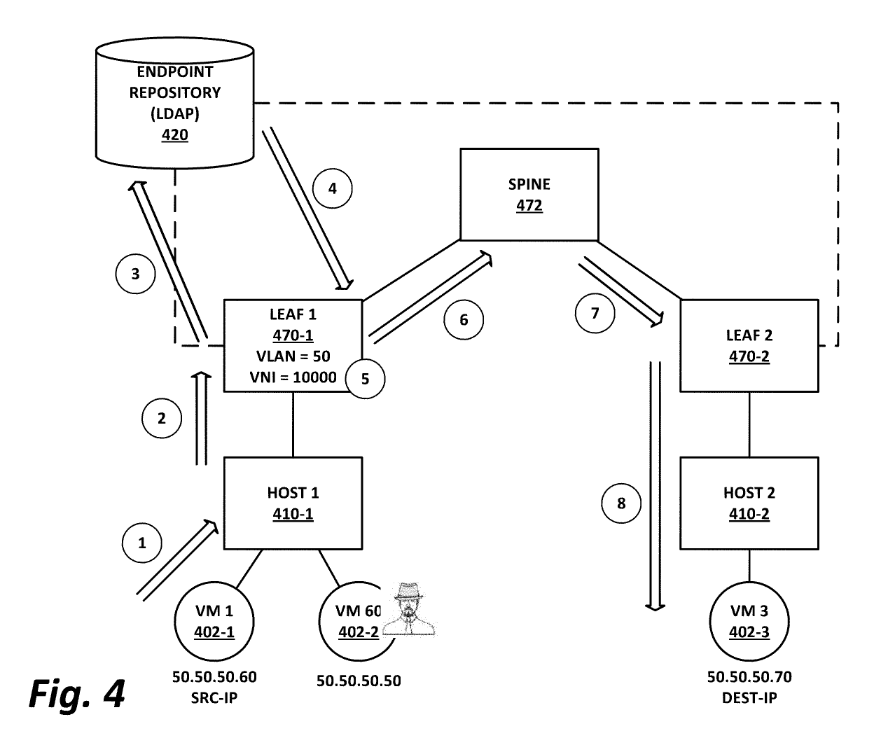

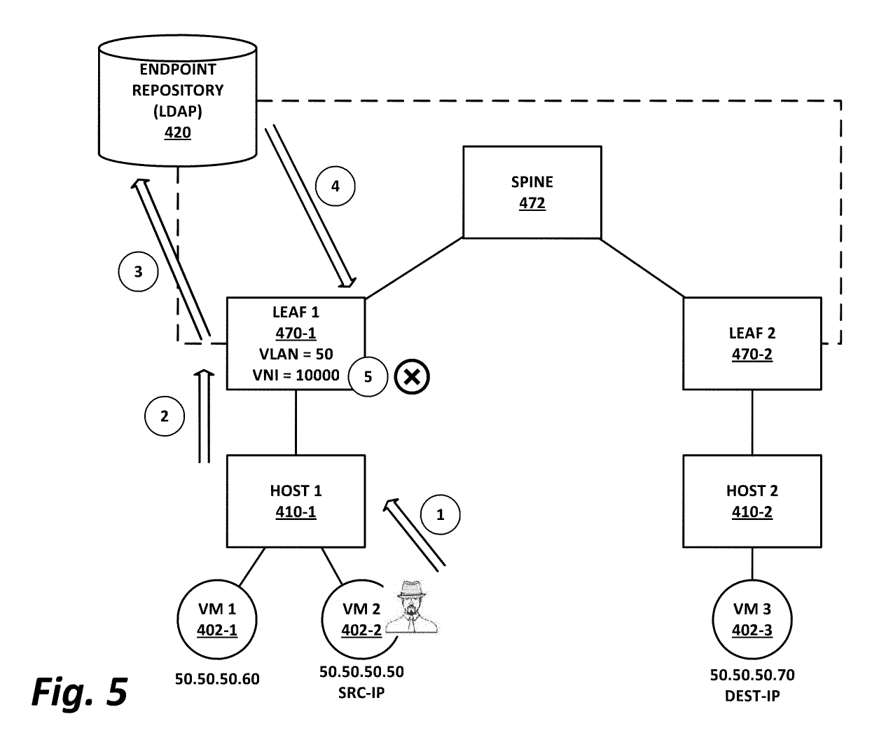

Note that server 300 of FIG. 3 illustrates, in particular, the classic “Von Neumann Architecture” aspects of server 300, with a focus on functional blocks. Other FIGURES herein (e.g. FIGS. 4a, 4b, and 5 below) may illustrate other aspects of a client or server device, with more focus on virtualization aspects. These illustrated embodiments are not intended to be mutually exclusive or to infer a necessary distinction. Rather, the various views and diagrams are intended to illustrate different perspectives and aspects of these devices.

In a particular example, server device 300 may be a memory server as illustrated herein.

Server 300 includes a processor 310 connected to a memory 320, having stored therein executable instructions for providing an operating system 322 and at least software portions of a memory endpoint control engine 324. Other components of server 300 include a storage 350, and host fabric interface 360. As described in FIG. 2, each logical block may be provided by one or more similar or dissimilar logic elements.

In an example, processor 310 is communicatively coupled to memory 320 via memory bus 370-3, which may be, for example, a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type. Memory 320 may include a persistent fast memory, such as 3DXP or similar.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of memory endpoint control engine 324.

Host fabric interface 360 may be provided to communicatively couple server 300 to a wired or wireless network, including a host fabric. A host fabric may include a switched interface for communicatively coupling nodes in a cloud or cloud-like environment. HFI 360 is used by way of example here, though any other suitable network interface (as discussed in connection with network interface 260) may be used.

Memory endpoint control engine 324 is an engine as described in FIG. 2 and, in one example, includes one or more logic elements operable to carry out computer-implemented methods as described in this specification. Software portions of memory endpoint control engine 324 may run as a daemon process.

Memory endpoint control engine 324 may include one or more nontransitory computer-readable mediums having stored thereon executable instructions operable to instruct a processor to provide memory endpoint control engine 324. At an appropriate time, such as upon booting server 300 or upon a command from operating system 322 or a user 120 or security administrator 150, processor 310 may retrieve a copy of memory endpoint control engine 324 (or software portions thereof) from storage 350 and load it into memory 320. Processor 310 may then iteratively execute the instructions of memory endpoint control engine 324 to provide the desired method.

FIG. 4 is a block diagram of a data center in a leaf spine architecture according to one or more examples of the present specification. In the example of FIG. 4, a plurality of leaf nodes 470 are connected to a spine 472. Leaf nodes 470 may be switches, such as leaf spine architecture switches provided by Cisco®. Spine 472 may also be a switch, that may be configured differently so as to operate as a spine in the leaf spine architecture.

In this case, leaf 1 470-1 has connected thereto a host 1 410-1. Host 1 410-1 may be a rackmount server, blade, or other server device as described in connection with FIG. 3. In accordance with known virtualization techniques, host 1 410-1 is configured to host a number of virtual machines, in this case VM 1 402-1, and VM 2 402-2. In this example, VM 1 402-1 has IP address 50.50.50.50, and is associated with VNI 10000. VM 2 402-2 has IP address 50.50.50.60.

As illustrated, leaf 1 470-1 has VLAN 50 mapped to VNI 10000. Input repository 420 may be a database, file server, or other data structure configured to provide endpoint repository data services. In one nonlimiting example, endpoint repository 420 is an LDAP server. Note that in one example, endpoint repository 420 is provided external to leaf 1 470-1, rather than being hosted internally on leaf 1 470-1. In an example, endpoint repository may include LDAP entries, including the following:

| IP | VNI | . . . |
|---|---|---|
| 50.50.50.60 | 10000 | . . . |
| 50.50.50.90 | 20000 | . . . |
| . . . | | |

FIG. 4 illustrates a series of operations that may be undertaken in performing packet forwarding. For example, in operation one, VM 1 402-1 sends a packet with source IP 50.50.50.60 to destination 50.50.50.70, which is VM 3 402-3. In operation 1, the packet is delivered to host 1 410-1.

In operation 2, host 1 410-1 delivers the packet to leaf 1 470-1. Leaf 1 470-1 has VLAN 50 mapped to VNI 10000. Leaf 1 470-1 receives a packet on an ingress interface. Operating an endpoint repository interface, leaf 1 470-1 queries endpoint repository 420 to determine whether source IP 50.50.50.60 is validly paired with VNI 10000 in the endpoint repository, such as the LDAP database.

Endpoint repository 420 queries its internal LDAP table, and determines that IP address 50.50.50.60 is validly paired with VNI 10000, and thus returns to leaf 470-1 and acknowledgment. The acknowledgment indicates to leaf 1 470-1 that the query was successful, and that the packet is valid.

Based on the acknowledgment from endpoint repository 420, in operation 5, leaf 1 470-1 allows the packet, and internally programs its ARP table with the appropriate data.

In operation 6, leaf 1 470-1 sends the packet out over its egress interface to spine 472. Spine 472 receives the packet on an ingress interface.

In operation 7, spine 472 sends the packet out over an egress interface, and leaf 2 470-2 receives the packet on an ingress interface.

In operation 8, leaf 2 470-2 sends the packet out over an egress interface to host 2 410-2, which delivers the packet to its VM 3 402-3 at destination IP address 50.50.50.70.

This interaction represents a successful delivery of a packet.

FIG. 5 is a block diagram of the data center in which a packet is not successfully delivered. It should be noted that the failure of delivery of the packet may not necessarily be due to intentional or malicious activity. While this can be the case, there are also cases where an invalid packet can simply come from a misconfigured host. However, the malware issue is nontrivial, because if an attacker is able to compromise one of the hosts host virtual machines, it may be possible to carry out a deliberate denial of service (DDOS) attack by flooding the switch with invalid packets.

In the example of FIG. 5, VM 2 402-2 originates the packet with source IP 50.50.50.50. In this case, the packet has a destination IP of 50.50.50.70.

As before, in operation one, VM 2 402-2, which is either compromised by malware, or is misconfigured, delivers the packet to host 1 410-1.

In operation 2, host 1 410-1 delivers the packet to leaf 1 470-1, which receives the packet on an ingress interface. As before, leaf 1 has VLAN 50 mapped to VNI 10000.

In operation 3, leaf 1 470-1 operates in endpoint repository interface to query endpoint repository 420 for the combination of IP address 50.50.50.50 and VNI 10000.

Endpoint repository 420 queries its database, such as an LDAP database, to determine whether there is a valid entry for the combination of IP address 50.50.50.50 and VNI 10000. In this case, there is no corresponding entry in the LDAP table. Thus, endpoint repository 420 delivers a NAK (not acknowledge) to leaf 1 470-1 via the endpoint repository interface.

In operation 5, leaf 1 470-1 receives the NAK via the endpoint repository interface, and determining that the packet is not valid, leaf 1 470-1 drops the packet.

Depending on the configuration, leaf 1 470-1 may also take remedial action, such as designating the packet as suspicious, and permitting it to be subjected to additional analysis, such as via deep packet inspection, or leaf 1 470-1 may notify a network administrator.

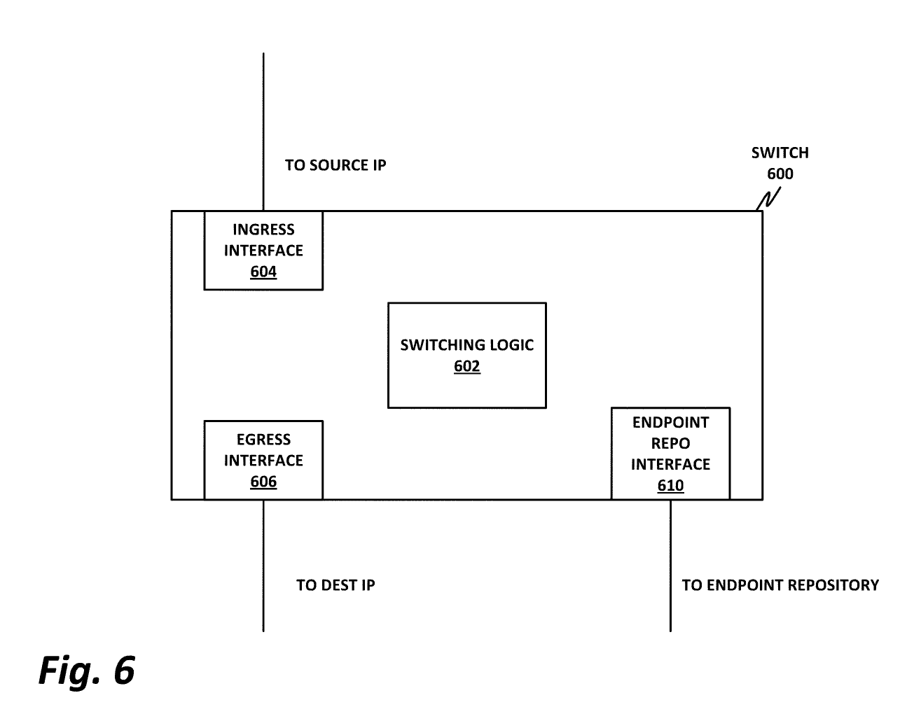

FIG. 6 is a block diagram of a switch 600 according to one or more examples of the present specification. Note that switch 600 may be in general terms an embodiment of a server class device 300 as illustrated in FIG. 3. However, switch 600 is illustrated here separately to illustrate specific features of a switch 600. In the preceding FIGS. 4 and 5, leaf switches 470 and spine switches 472 could all be examples of a switch 600.

In this example, switch 600 includes switching logic 602, which enables switch 600 to perform its ordinary switching functions. In some examples, switching logic 602 may also include an admission control engine, as illustrated in admission control engine 324 of FIG. 3.

Switch 600 also includes one or more ingress interfaces 604, and one or more egress interfaces 606. In general terms, the incoming packet may arrive from the source IP address on an ingress interface 604, be processed by switching logic, including the performance of endpoint control, and may be delivered to egress interface 606. Egress interface 606 delivers the packet to the destination IP address.

In this example, switch 600 also includes an endpoint repository interface 610. Endpoint repository interface 610 allows switch 600 to communicatively couple to an appropriate endpoint repository, such as endpoint repository 420 of FIG. 4. Operating endpoint repository interface 610, switch 600 can issue queries to endpoint repository 420, and can receive responses back from endpoint repository 420.

Note that the interfaces shown herein may include both physical interfaces, such as Ethernet ports, PCIe connections, or other physical interconnects, as well as logic to provide the interface. Depending on the embodiment, the logic for providing the various interfaces may be provided in software, in which case the logic may be partly embodied in switching logic 602, or in some cases, may be provided in hardware, such as an ASIC or FPGA, which in some cases may provide a so-called “intelligent NIC, or iNIC.”

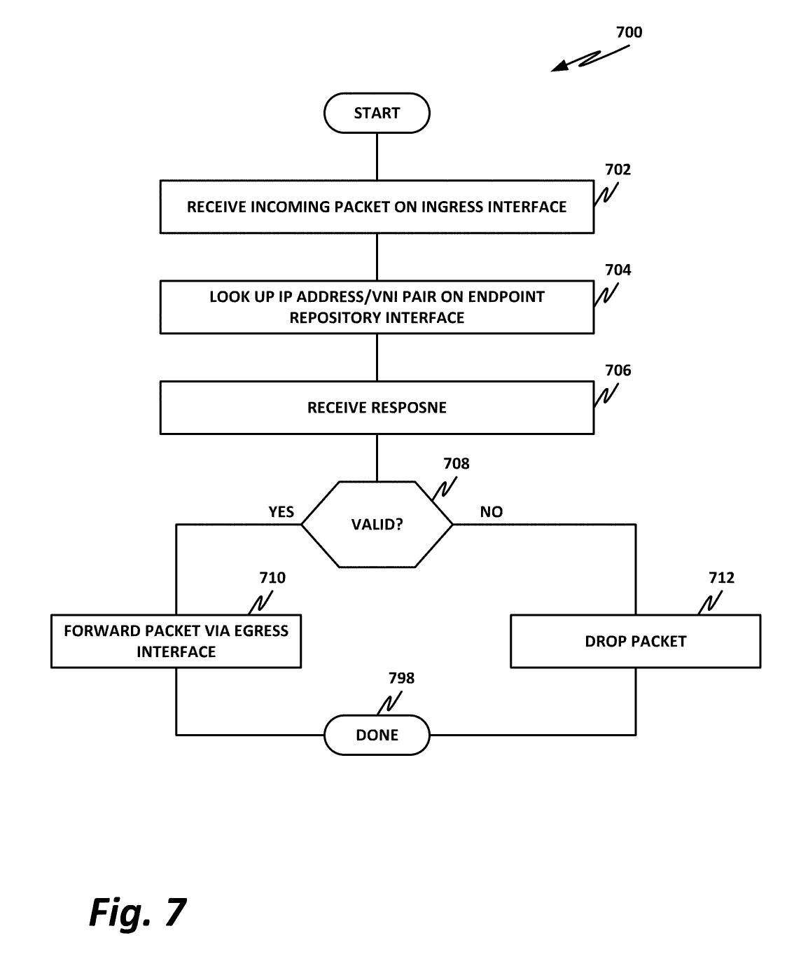

FIG. 7 is a flowchart of a method 700 of performing endpoint control according to one or more examples of the present specification.

In block 702, a switch, which may be operating (for example, as a leaf in a leaf spine network) as a spoke in a hub spoke network, or in any other suitable network configuration, receives on its ingress interface an incoming packet.

In block 704, the switch operates its endpoint repository interface to perform a lookup in the endpoint repository, such as an LDAP database, of the IP address and VNI combination of the incoming packet.

In block 706, the switch receives from the endpoint repository via the endpoint repository interface a response to the query. The response may be, for example, an ACK or a NAK, indicating either that the lookup was successful, or that the lookup failed. Other messaging protocols or semantics may be used according to the needs of a particular embodiment.

In decision block 708, the switch determines whether the packet is valid, basing the decision at least in part on the response from the endpoint repository. If the packet is valid, then in block 710, the switch forwards the packet via the egress interface, so that it can be delivered to its destination IP address. In addition to forwarding the packet to the egress interface, the switch also updates the ARP table.

Returning to block 708, if the packet is not valid, then in block 712, the switch may drop the packet. In some embodiments, the switch may also take remedial measures, such as marking the packet as suspicious or notifying a security administrator. After either forwarding the packet via the egress interface or dropping the packet, in block 798, the method is done.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including central processing unit (CPU) package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), field-programmable gate arrays (FPGAs), and other semiconductor chips.

Note also that in certain embodiments, some of the components may be omitted or consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field-programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage may store information in any suitable type of tangible, nontransitory storage medium (for example, random access memory (RAM), read only memory (ROM), field-programmable gate array (FPGA), erasable programmable read only memory (EPROM), electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein should be construed as being encompassed within the broad terms ‘memory’ and ‘storage,’ as appropriate. A nontransitory storage medium herein is expressly intended to include any nontransitory special-purpose or programmable hardware configured to provide the disclosed operations, or to cause a processor to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g. via an interpreter), or the source code may be converted (e.g. via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### Example Implementations

There is disclosed, in one example, a network switch, comprising: an ingress interface; an egress interface; an endpoint repository network interface; and one or more logic elements comprising an endpoint admission control engine to: receive a packet on the ingress interface, the packet having an associated source Internet protocol (IP) address and virtual network identifier (VNI); query an endpoint repository via the endpoint repository network interface for the source IP address and VNI; determine that the source IP address and VNI are found in an endpoint repository database of the endpoint repository; and forward the packet to a destination IP address via the egress interface.

There is further disclosed an example, wherein the packet is an address resolution protocol (ARP) packet.

There is further disclosed an example, wherein the endpoint admission control engine is further to determine that the source IP address and VNI is not found in the endpoint repository database, and drop the packet.

There is further disclosed an example, wherein the endpoint admission control engine is further to install an access control list (ACL) to prevent packets from an endpoint.

There is further disclosed an example, wherein the endpoint admission control engine is further to install a media access control (MAC) rule to drop packets from an endpoint.

There is further disclosed an example, wherein the endpoint admission control engine is further to provide a notification to a network operator of the dropped packet.

There is further disclosed an example, wherein the endpoint repository database is a lightweight directory access protocol (LDAP) database.

There is further disclosed an example, wherein the network switch is a first-hop network switch from an endpoint.

There is further disclosed an example, wherein the network switch is a first-hop leaf switch from an endpoint in a leaf spine architecture.

There is further disclosed an example, wherein an endpoint is a virtual machine.

There is further disclosed an example of one or more tangible, non-transitory computer-readable mediums having stored thereon executable instructions to instruct a processor and one or more logic elements comprising an endpoint admission control engine to: receive a packet on an ingress interface, query an endpoint repository via an endpoint repository network interface, and forward the packet on an egress interface, the packet having an associated source Internet protocol (IP) address and virtual network identifier (VNI); query an endpoint repository via the endpoint repository network interface for the source IP address and VNI; determine that the source IP address and VNI are found in an endpoint repository database of the endpoint repository; and forward the packet to a destination IP address via the egress interface.

There is further disclosed an example, wherein the packet is an address resolution protocol (ARP) packet.

There is further disclosed an example, wherein the endpoint admission control engine is further to determine that the source IP address and VNI is not found in the endpoint repository database, and drop the packet.

There is further disclosed an example, wherein the endpoint admission control engine is further to install an access control list (ACL) to prevent packets from an endpoint.

There is further disclosed an example, wherein the network switch is a first-hop network switch from an endpoint.

There is further disclosed an example, wherein the network switch is a first-hop leaf switch from an endpoint in a leaf spine architecture.

There is further disclosed an example, wherein an endpoint is a virtual machine.

There is further disclosed an example of a computer-implemented method, comprising: an ingress interface; an egress interface; an endpoint repository network interface; and one or more logic elements comprising an endpoint admission control engine to: receive a packet on the ingress interface, the packet having an associated source Internet protocol (IP) address and virtual network identifier (VNI); query an endpoint repository via the endpoint repository network interface for the source IP address and VNI; determine that the source IP address and VNI are found in an endpoint repository database of the endpoint repository; and forward the packet to a destination IP address via the egress interface.

There is further disclosed an example, wherein the packet is an address resolution protocol (ARP) packet.

There is further disclosed an example, wherein the endpoint admission control engine is further to determine that the source IP address and VNI is not found in the endpoint repository database, and drop the packet.

What is claimed is:

1. A network switch, comprising:
an ingress interface;
an egress interface;
an endpoint repository network interface; and
one or more logic elements comprising an endpoint admission control engine to:
receive a packet on the ingress interface, the packet having an associated source Internet protocol (IP) address and virtual network identifier (VNI);
query an endpoint repository via the endpoint repository network interface for the source IP address and VNI;
determine that the source IP address and VNI are found in an endpoint repository database of the endpoint repository; and
forward the packet to a destination IP address via the egress interface.

2. The network switch of claim 1, wherein the packet is an address resolution protocol (ARP) packet.

3. The network switch of claim 1, wherein the endpoint admission control engine is further to determine that the source IP address and VNI is not found in the endpoint repository database, and drop the packet.

4. The network switch of claim 3, wherein the endpoint admission control engine is further to install an access control list (ACL) to prevent packets from an endpoint.

5. The network switch of claim 3, wherein the endpoint admission control engine is further to install a media access control (MAC) rule to drop packets from an endpoint.

6. The network switch of claim 3, wherein the endpoint admission control engine is further to provide a notification to a network operator of the dropped packet.

7. The network switch of claim 1, wherein the endpoint repository database is a lightweight directory access protocol (LDAP) database.

8. The network switch of claim 1, wherein the network switch is a first-hop network switch from an endpoint.

9. The network switch of claim 1, wherein the network switch is a first-hop leaf switch from an endpoint in a leaf spine architecture.

10. The network switch of claim 1, wherein an endpoint is a virtual machine.

11. One or more tangible, non-transitory computer-readable mediums having stored thereon executable instructions to instruct a processor and one or more logic elements comprising an endpoint admission control engine to:
receive a packet on an ingress interface,
query an endpoint repository via an endpoint repository network interface,
and forward the packet on an egress interface, the packet having an associated source Internet protocol (IP) address and virtual network identifier (VNI);
query an endpoint repository via the endpoint repository network interface for the source IP address and VNI;
determine that the source IP address and VNI are found in an endpoint repository database of the endpoint repository; and
forward the packet to a destination IP address via the egress interface.

12. The one or more tangible, non-transitory computer-readable mediums of claim 11, wherein the packet is an address resolution protocol (ARP) packet.

13. The one or more tangible, non-transitory computer-readable mediums of claim 11, wherein the endpoint admission control engine is further to determine that the source IP address and VNI is not found in the endpoint repository database, and drop the packet.

14. The one or more tangible, non-transitory computer-readable mediums of claim 11, wherein the endpoint admission control engine is further to install an access control list (ACL) to prevent packets from an endpoint.

15. The one or more tangible, non-transitory computer-readable mediums of claim 11, wherein the network switch is a first-hop network switch from an endpoint.

16. The one or more tangible, non-transitory computer-readable mediums of claim 11, wherein the network switch is a first-hop leaf switch from an endpoint in a leaf spine architecture.

17. The network switch of claim 11, wherein an endpoint is a virtual machine.

18. A computer-implemented method, comprising:
an ingress interface;
an egress interface;
an endpoint repository network interface; and
one or more logic elements comprising an endpoint admission control engine to:
receive a packet on the ingress interface, the packet having an associated source Internet protocol (IP) address and virtual network identifier (VNI);
query an endpoint repository via the endpoint repository network interface for the source IP address and VNI;
determine that the source IP address and VNI are found in an endpoint repository database of the endpoint repository; and
forward the packet to a destination IP address via the egress interface.

19. The computer-implemented method of claim 18, wherein the packet is an address resolution protocol (ARP) packet.

20. The computer-implemented method of claim 18, wherein the endpoint admission control engine is further to determine that the source IP address and VNI is not found in the endpoint repository database, and drop the packet.
